(19) United States
(12) Patent Application Publication
(10) Pub. No.: US 2013/0251133 A1
(43) Pub. Date: Sep. 26, 2013

(54) ESTABLISHING A CONNECTION TO A CALLED TERMINAL BEING CONNECTED TO DIFFERENT NETWORKS

(71) Applicant: Manuel Nunez Sans, Madrid (ES)

(72) Inventor: Manuel Nunez Sans, Madrid (ES)

(21) Appl. No.: 13/812,243

(22) PCT Filed: Jul. 7, 2011
(86) PCT No.: PCT/EP11/61468

§ 371 Date: Jun. 11, 2013

(30) Foreign Application Priority Data
Jul. 27, 2010 (ES) P201031160

(51) Int. Cl. H04M 3/02

(52) U.S. Cl. CPC H04M 3/02
USPC 379/221.09; 379/220.01

(57) ABSTRACT

Method and system of establishing a connection between a calling terminal (1) and a called terminal (2) which allows the called terminal (2) to receive calls trough two different networks (3, 4), for example a circuit switched network and a Internet protocol Multimedia Subsystem, using a single number, thanks to a control element which determines the network to be used to reach the called terminal (2), and its number in said network to be used.

### FIELD OF THE INVENTION

The present invention has its application within the telecommunications sector and, especially, in the field of communication networks.

### BACKGROUND OF THE INVENTION

Many telecommunications operators are migrating from their traditional circuit switched (CS) networks, such as the Public Switched Telephone Network (PSTN) or the Public land mobile network (PLMN), to Next Generation Networking, such as

Internet Protocol Multimedia Subsystem (IMS). In this scenario, both technologies are required to coexist and interwork, as the migration process may span several years.

The way in which CS and IMS networks must interwork has been standardized, dealing with the problem of routing incoming calls to the proper domain. Traditional solutions rely on dial plans (also called “numbering plans”), which indicate which telephone numbers (also called MSISDN, “Mobile Station International Subscriber Directory Number”) correspond to each network. Thanks to the hierarchical nature of the dial plans, and its geographical basis, most calls can be routed based only on their prefix, although there are some exceptions, like intelligent network services with non-geographical numbers.

Both CS and IMS networks use these plans when routing calls to other networks. If a calls is originated in a IMS network and the called number is connected to a CS network, a Breakout Gateway Control Function (BGCF) determines which Media Gateway Control Function (MGCF) the call should go through to reach the desired network, according to the dial plan. The BGCF is thus a Session Initiation Protocol (SIP) server which includes routing functionalities based on telephone numbers.

On the other hand, If a calls is originated in a CS network and the called number is connected to a IMS network, the call is routed to the phone operator's Gateway Mobile Switching Centre (MSC), which relies on the dial plans to connect to the IMS network.

In both scenarios, if a user migrates to another network, an exception needs to be indicated in the original dial plan to allow the user to keep his or her telephone number and still be reached in the network to which he or she is transferred.

Portability issues have been tackled, for example in WO 2007/130323 A1, which presents an apparatus and method to perform a static number portability in a IMS network; and EP 1,761,077 B1, which presents a method to allow portability between two IMS networks.

However, in this state of the art, if a user desires to be reachable through both CS and IMS networks, said user needs two different telephone numbers, and cannot choose the network through which to receive calls at a given time, as it is determined by the dialled number. Thus, there is the need of methods and systems that allow users whose terminals are able to work in both CS and IMS networks to dynamically choose through which networks to receive calls, using a single telephone number for both of the networks.

### SUMMARY OF THE INVENTION

The current invention solves the aforementioned problems by disclosing a method and system that allows a user to receive calls through any of two available communication networks according to his or her preferences using a single number as identification.

In a first aspect of the present invention, a method of establishing a connection between two terminals (calling terminal and called terminal) is disclosed. In the scenario in which the present invention applies, the calling terminal is capable of connecting to a first network, preferably a CS network, while the called terminal is capable of connecting to both the CS network and a second network, preferably an IMS network. It should be noted that additional connections to other networks can be established without interfering with the disclosed invention, and thus, the calling terminal and the called terminal may have additional connection capabilities as long as they verify the stated requirements.

In this scenario, if the calling terminal is connected to the first network and it uses said first network to send a request to establish a connection with the called terminal, said request is received by a gateway of the first network, which responds by requesting the necessary routing information to establish the connection. In a CS network, said request is preferably handled by a Service Control Point (SCP). According to the method of the invention, the SCP (or another control element) receives the request from the gateway and responds with a message that comprises an indication of the network that is to be used to reach the called terminal, as well as an identifier (such as a telephone number) of the called terminal in said network. Preferably, the network to be used is determined according to preferences of the user of the called terminal. These preferences may be established as unconditional priorities as well as conditions according to the state of the networks and the terminal.

With the information provided by the control element, the gateway of the first network is able to establish the connection through the network indicated in the message (the first network or the second network). As the decision of which network to use is performed by the control element, which also provides the necessary routing information (that is, the aforementioned identifier in the network through which the connection is finally established), the calling terminal only needs to know a single identifier of the called terminal, which is thus able to use both networks without the need of using independent identifiers for each one.

Preferably, the method comprises a previous registration step in which the control element receives a register request from the called terminal. In response to this register request, the control element assigns a dynamic identifier in the second network to the called terminal, for example, from a pool of numbers previously assigned to that purpose. Finally, in the registration step the preferences and conditions that determine which network is to be used to reach the called terminal in each situation are established.

In another aspect of the present invention, a system of establishing a connection between two terminals is disclosed. The system comprises a control element (such as the SCP in a CS network) that performs the described method, thus allowing the called terminal to be reached through two different networks using a single identifier.

These and other advantages will be apparent in the light of the detailed description of the invention.

### BRIEF DESCRIPTION OF THE DRAWINGS

For the purpose of aiding the understanding of the characteristics of the invention, according to a preferred practical embodiment thereof and in order to complement this description, the following figures are attached as an integral part thereof, having an illustrative and non-limiting character:

FIG. 1 shows a schematic representation of a particular embodiment of the system of the invention, as well as some other elements of a CS network and an IMS network that take part in the communication process.

FIG. 2 presents a flow diagram of a registration request.

FIG. 3 shows a flow diagram of a de-registration request.

FIG. 4 presents an example of connection establishment in which the called terminal is only connected to a CS network.

FIG. 5 shows an example of a flow diagram of a connection establishment according a particular embodiment to the method of the invention.

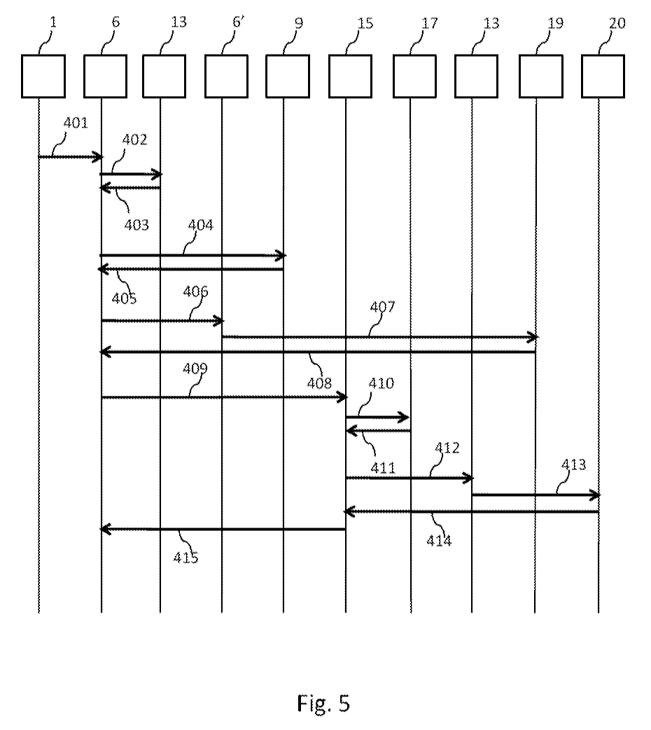

### DETAILED DESCRIPTION OF THE INVENTION

The matters defined in this detailed description are provided to assist in a comprehensive understanding of the invention. Accordingly, those of ordinary skill in the art will recognize that variations, changes and modifications of the embodiments described herein can be made without departing from the scope and spirit of the invention.

Note that in this text, the term “comprises” and its derivations (such as “comprising”, etc.) should not be understood in an excluding sense, that is, these terms should not be interpreted as excluding the possibility that what is described and defined may include further elements, steps, etc.

The terms “called terminal” and “called party” are used indistinctively in this text, and they refer to a device which can receive calls with the present method and system, even when there is no active connection, for example, during the registration process.

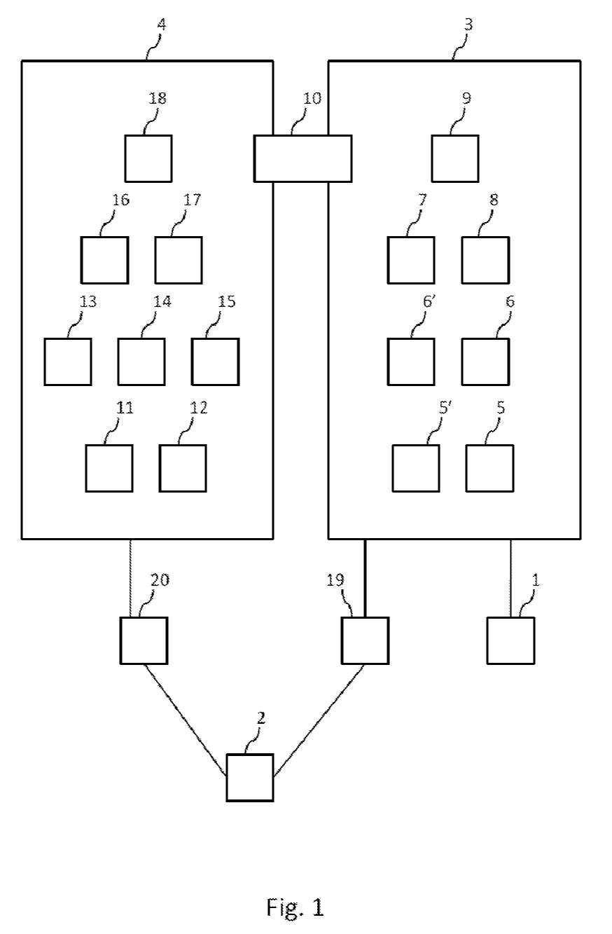

FIG. 1 shows some elements of a CS network 3 and an IMS network 4 involved in the communication between a calling terminal 1 and a called terminal 2. The calling terminal 1 is connected to the CS network 3, while the called terminal 2 is connected to the CS network 3 (with a CS number 19) and to the IMS network 4 (with a IMS telephone number 20). It should be noted that, although the called terminal 2 has a telephone number in each network, the system and method hereby disclosed allow the calling terminal 1 to reach the called terminal 2 through both networks using only one of the numbers.

CS network 3 comprises at least a first Mobile Media Gateway (M-MGW) 5 which provides service to the calling terminal 1 and a second M-MGW 5′ which provides service to the called terminal 2. Each terminal also has an associated Mobile Switching Center (MSC), that is, calling terminal MSC 6 and called terminal MSC 6′. Also, the CS network 3 comprises a Session Description Protocol (SDP) 7 and a Home Location Register (HLR) 8 in the user's data plane and a SCP 9 in the application plane. Finally, the CS network 3 is connected to the IMS network 4 by a call handling Application Program Interface (API) 10.

IMS network 4 comprises IP core 11, Media Gateway (MGW) 12, Call Sesion Control Function (CSCF) 13, BGCF 14 and SGW 15 in the signalling plane. The IMS user's data plane comprises Home Subscriber Service (HSS) 6 and Domain Naming System/Enumeration (DNS/ENUM) 7. Finally, according to a preferred embodiment of the present invention, the IMS network 4 comprises in its application plane an Application Service (AS) 18 which is responsible of configuring the SCP 9 of the CS network 3. The AS 18 has a subscription to the Reg event state, and has a pool of IMS phone number (that is, E.164 addresses) available to be assigned. Any number in this pool is unconditionally routed by the CS network to the IMS network.

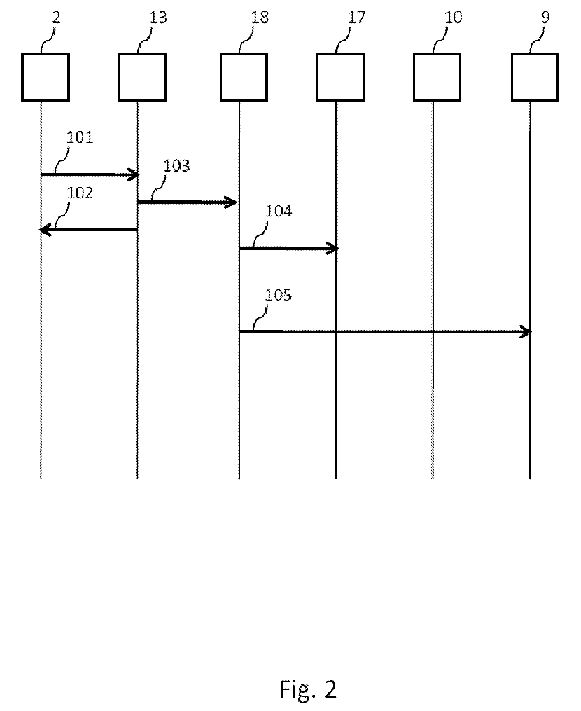

FIG. 2 presents a scheme of a registration process requested by the called terminal 2. The called terminal sends a register request 101 to the CSCF 13, which responds with an acknowledgement message 102 (ACK), and also sends register request info 103 to the AS 18. The AS 18 gets the CS phone number 19 and the user preferences, either from the register request info 103 or from its own database, HSS 16. The AS also chooses a free IMS phone number from the number pool and associates this dynamic IMS phone number with the CS phone number 19 of the user, and updates 104 the DNS/ENUM 17 with this association. Then, the AS 18 sends the SCP 9 the instructions 105 determining how to handle future calls to the called user according to his or her preferences and to different possible scenarios, like the following:

Called Party is not reachable.

Called Party not answer.

Called Party is busy.

After the registration process, the CS number 19 is re-routed to the IMS number 20 conditioned by the above cases and user's preferences. The interface between the AS 18 and SCP 9 can be connected directly using a SCP protocol or through the Call Handling API 10 interface.

Figure shows an example of a de-registration process started by the called terminal 2. Called terminal 2 sends a de-registration request 201 to the CSCF 13, which responds with an acknowledgement message 202 (ACK), and also sends de-register request info 203 to the AS 18. AS 18 sends an update message 204 to the DNS/ENUM 7, thus freeing the dynamic IMS telephone number previously assigned to the called terminal. AS 18 additionally sends a reconfiguration message 205 to SCP 9, after which SCP 9 stops rerouting calls to the IMS telephone number 20.

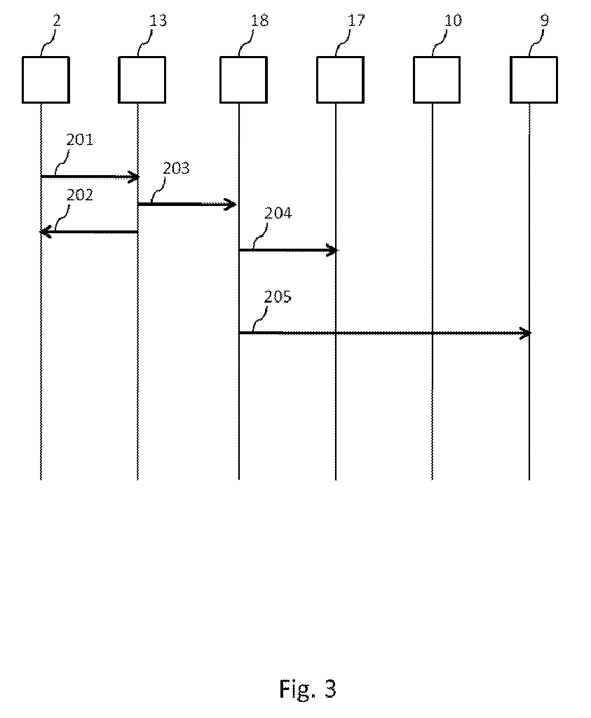

FIG. 3 presents an example of communication establishment in which the called terminal 2 is registered in the AS 18 but is nevertheless only connected to CS network 3. Calling terminal 1 sends a ringing message 301 to the calling terminal MSC 6, which sends a request 302 for information to HLR/VLR 13. HLR/VLR 13 sends the requested information 303 to the calling terminal MSC 6, which allows calling terminal MSC 6 to send a request for routing information 304 to SCP 9. SCP 9 sends the requested routing information 305 (including the network to be used and the number of the called terminal in said network, which in this case is the original CS telephone number 19 used by the calling terminal 1 to start the communication), and calling terminal MSC 6 connects 306 to called terminal MSC 6′, which establishes a connection 307 with the called terminal 2 through its CS number 19. Called terminal 2 is thus able to answer 308 the call through the CS network 3.

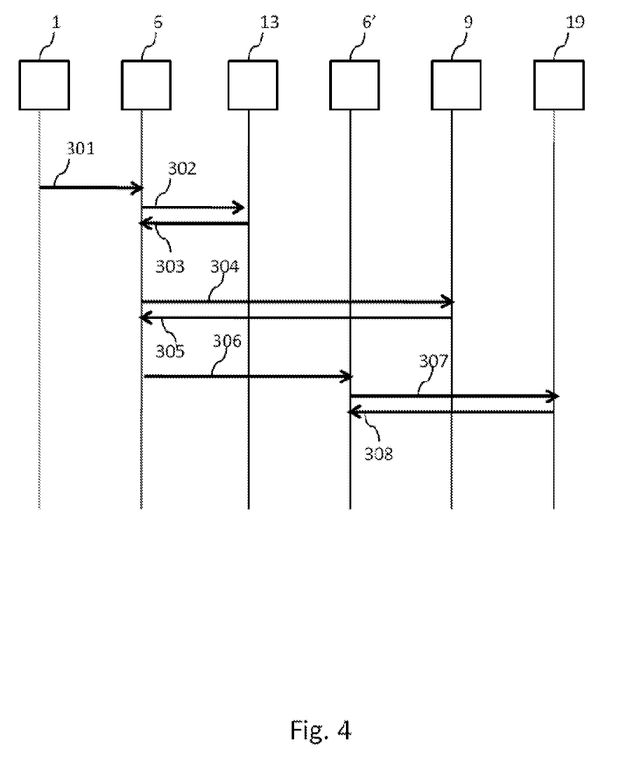

FIG. 4 shows another example in which the called terminal 2 is connected to both CS network 3 and IMS network 4, and is thus reachable through both networks. In this particular example, the preferences of the user are such that incoming calls are to be routed to the CS telephone number 19 and then to the IMS network 4 if said CS telephone number 19 is not reachable or does not answer.

For this reason, the first steps are performed as in the previous example: calling terminal 1 sends a ringing message 401 to the calling terminal MSC 6 addressed to the called terminal CS number 19. Calling terminal 6 then sends a request 402 for information to HLR/VLR 13. HLR/VLR 13 sends the requested information 403 to the calling terminal MSC 6, which sends a request for routing information 404 to SCP 9. SCP 9 sends the requested routing information 405, which includes the calling terminal dynamic IMS number 20 and the indication of first trying the CS network. Calling terminal MSC 6 connects 406 to called terminal MSC 6′, which tries to establish a connection 407 with the called terminal CS number 19. In this example, CS number 19 cannot be reached, and calling terminal MSC 6 is thus informed of this event 408. As a result, calling terminal MSC 6 tries to establish a connection through the IMS network 4, and thus sends a call 409 to SGW 15 addressed to the called terminal dynamic IMS telephone number 20 (previously provided by SCP 9). SGW 15 checks 410 the DNS/ENUM 17, receiving a response 411 from said DSN/ENUM. This response 411 allows the SGW 15 to ring 412 the CSCF 13, which transmits the ringing 413 to the called terminal 2 through its IMS number 20. Answer 414 is thus sent to the SGW 15, which finally establishes the connection 415 with calling terminal 1.

Thanks to the disclosed method and system, the called terminal can be reached trough both CS and IMS networks, prioritizing any of them according to its user's preferences , and the calling terminal only needs a single telephone number to request the connection through said networks.

1. Method of establishing a connection between a calling terminal and a called terminal, wherein the called terminal is capable of connecting to a first network and to a second network, and wherein the calling terminal is capable of connecting to the first network,
characterised in that
if the calling terminal is connected to the first network and the called terminal is connected to both the first network and the second network, the method comprises:
receiving a request from a gateway of the first network;
sending to the gateway of the first network a message indicating a network to be used to establish the connection with the called terminal, and an identifier of the called terminal in said network to be used, being said network to be used either the first network or the second network.

2. Method according to claim 1 wherein the network to be used is determined according to preferences of a user of the called terminal.

3. Method according to any of the previous claims characterised in that the first network is a circuit switched network and the steps of receiving a request and sending a message are performed by a Service Control Point of said switched network.

4. Method according to any of the previous claims characterised in that the second network is an Internet Protocol Multimedia Subsytem.

5. Method according to any of the previous claims characterised by further comprising receiving a register request from the called terminal via the second network, assigning to the called terminal a dynamic identifier in said second network, and setting conditions that determine the network to be used.

6. System of establishing a connection between a calling terminal and a called terminal, wherein the called terminal is capable of connecting to a first network and to a second network, and wherein the calling terminal is capable of connecting to the first network,
characterised by comprising a control element in the first network configured to, if the calling terminal is connected to the first network and the called terminal is connected to both the first network and the second network:
receive a request from a gateway of said first network;
send to the gateway of the first network a message indicating a network to be used to establish the connection with the called terminal, and an identifier of the called terminal in said network to be used, being said network to be used either the first network or the second network.

7. System according to claim 6 wherein the control element is also configured to determine the network to be used according to preferences of a user of the called terminal.

8. System according to any of claims 6 and 7 characterised in that the first network is a circuit switched network and the control element is a Service Control Point.

9. System according to any of claims 6 to 8 characterised in that the second network is an Internet Protocol Multimedia Subsytem.

10. System according to any of claims 6 to 9 characterised in that the control element is also configured to receive a register request from the called terminal via the second network, to assign to the called terminal a dynamic identifier in said second network, and to set conditions that determine the network to be used.
